(19) United States
(12) Patent Application Publication
(10) Pub. No.: US 2013/0224568 A1
(43) Pub. Date: Aug. 29, 2013

(54) MOLTEN SALT BATTERY

(71) Applicants: Atsushi Fukunaga, Osaka-shi, Osaka (JP); Shoichiro Sakai, Osaka-shi, Osaka (JP); Koji Nitta, Osaka-shi, Osaka (JP); Atsushi Yamaguchi, Osaka-shi, Osaka (JP); Masatoshi Majima, Osaka-shi, Osaka (JP); Shinji Inazawa, Osaka-shi, Osaka (JP)

(72) Inventors: Atsushi Fukunaga, Osaka-shi, Osaka (JP); Shoichiro Sakai, Osaka-shi, Osaka (JP); Koji Nitta, Osaka-shi, Osaka (JP); Atsushi Yamaguchi, Osaka-shi, Osaka (JP); Masatoshi Majima, Osaka-shi, Osaka (JP); Shinji Inazawa, Osaka-shi, Osaka (JP)

(73) Assignee: SUMITOMO ELECTRIC INDUSTRIES, LTD., Osaka-shi, Osaka (JP)

(21) Appl. No.: 13/882,210

(22) PCT Filed: Oct. 28, 2011
(86) PCT No.: PCT/JP2011/074910

§ 371 Date: Apr. 29, 2013

(30) Foreign Application Priority Data
Oct. 29, 2010 (JP) 2010-244195
Mar. 10, 2011 (JP) 2011-053485

(51) Int. Cl. H01M 2/02

(52) U.S. Cl. CPC H01M 2/02; H01M 2/0202; H01M 2/024
USPC 429/160

(57) ABSTRACT

A plurality of rectangular plate-like negative electrodes and a plurality of rectangular plate-like positive electrodes are laterally stacked so as to face each other alternately with rectangular plate-like separators being respectively interposed therebetween, and are housed in a battery container formed of an aluminum alloy. The inner surface of the battery container is insulated by forming an alumite coating film thereon. Rectangular tabs (lead wires) for drawing a current from the positive electrodes are connected to one another via a tab lead, and rectangular tabs for drawing a current from the negative electrodes are connected to one another via a tab lead.

### TECHNICAL FIELD

The present invention relates to a molten salt battery using a molten salt for an electrolyte, and more particularly relates to a molten salt battery including a positive electrode and a negative electrode in a battery container, the positive electrode and the negative electrode facing each other with a separator interposed therebetween, the separator containing a molten salt.

### BACKGROUND ART

In recent years, electric power generation using natural energy such as sunlight and wind power has been promoted as a means for generating electric power without emission of carbon dioxide. In electric power generation by natural energy, leveling of electric power supply with respect to a load is absolutely necessary because not only the amount of electric power generation often depends on natural conditions such as climate and weather, but also it is difficult to adjust the amount of electric power generation in accordance with the demand for electric power. For achieving leveling by charging and discharging electric energy generated, a storage battery having a high energy density/high efficiency and a large capacity is required, and as a storage battery that satisfies such a requirement, a molten salt battery using a molten salt for an electrolyte has been receiving attention.

For instance, a molten salt battery has, in a battery container, an electric power generation element in which a separator impregnated with a molten salt composed of a cation of an alkali metal such as sodium or potassium and an anion including fluorine is interposed between a positive electrode formed by including, in a current-collector, active material composed of a compound of sodium and a negative electrode formed by plating the current-collector with a metal such as tin. The battery container is generally electrically insulated from the electric power generation element.

When the above-described molten salt battery is charged, the cation is released from the active material of the positive electrode, and forms an alloy with a metal on the surface of the negative electrode. At this time, at the positive electrode, the cation is released (deintercalated) from the crystal structure of the active material, so that the active material is expanded. When the charged molten salt battery is discharged, the cation released from the negative electrode is inserted (intercalated) into the active material of the positive electrode, and resultantly the active material of the positive electrode is shrunk.

This expansion/shrinkage associated with charging and discharging also occurs in, for example, lithium ion batteries, thus causing such problems as deformation and damage of electrodes and battery containers in some cases. As a measure against this problem, for example, Patent Literature 1 discloses a technique relating to a sealed-type rectangular storage battery, the internal pressure resistance strength of which is increased by curving the broad surface of an exterior can (battery container) so that it is recessed at the center.

### CITATION LIST

### Patent Literature

Patent Literature 1: Japanese Unexamined Patent Publication No. H05-013054

### SUMMARY OF INVENTION

### Technical Problem

In the technique disclosed in Patent Literature 1, however, when a positive electrode and a negative electrode are expanded/shrunk, the amount of change in pressing force applied to the positive electrode and the negative electrode by a battery container is increased in proportion to the strength of the battery container. On the other hand, since the positive electrode of the molten salt battery described above has a positive electrode current-collector which is porous and has a rough surface, with the positive electrode current-collector filled with a mixture containing granular active material, and also the battery container is provided on the inner surface with an insulating portion by, for example, forming an insulating film, the insulating portion in the battery container may be damaged by rubbing against the positive electrode, or the like when the amount of change in pressing force received by the positive electrode from the battery container is significant.

The present invention has been devised in view of such circumstances, and an object thereof is to provide a molten salt battery in which an insulating portion in a battery container is not ruptured even when a positive electrode and a negative electrode are expanded/shrunk.

### Solution to Problem

The molten salt battery according to the present invention is a molten salt battery including a positive electrode and a negative electrode housed in a battery container formed of a conductor, the positive electrode and the negative electrode facing each other with a separator interposed therebetween, the separator containing a molten salt, wherein the battery container is insulated against the positive electrode and the negative electrode; one or more of the positive electrodes, and a plurality of the separators and negative electrodes are included, respectively; the positive electrodes and the negative electrodes are stacked alternately, with negative electrodes placed at both ends in the stacking direction; and the positive electrodes and the negative electrodes are connected to one another in parallel, respectively.

In the present invention, negative electrodes are positioned at both ends in the stacking direction along which positive electrodes and negative electrodes are stacked alternately with separators interposed therebetween. That is, when a pair of a positive electrode and a negative electrode face each other, a separator and a negative electrode are additionally stacked on the positive electrode side, and when two or more positive electrodes and negative electrodes are stacked, and a positive electrode is positioned at one or both ends in the stacking direction, a separator and a negative electrode are additionally stacked on the positive electrode side at the end. The positive electrode and the negative electrode with negative electrodes placed at both ends in the stacking direction are housed in a battery container while being insulated from the battery container.

Consequently, the positive electrode no longer contacts an insulating portion between the positive/negative electrodes and the battery container, so that the insulating portion is free from influence of the surface roughness of the positive electrode even when the order of the surface roughness of the positive electrode is greater than the order of the thickness of the insulating portion. For the negative electrode, on the other hand, a current-collector and active material are formed of a metal having a relatively smooth surface, so that the surface roughness of the negative electrode has no influences on the insulating portion even when the negative electrode rubs against the insulating portion.

When there are a plurality of positive electrodes, positive electrodes are connected to one another, and a plurality of negative electrodes are connected to one another, so that all the positive electrodes and the negative electrodes in the battery container can be treated as a pair of a positive electrode and a negative electrode.

The molten salt battery according to the present invention has a feature in that an insulating film is formed partially or entirely on the inner surface of the battery container.

In the present invention, the insulating film is formed on the inner surface of the battery container, and when a portion in contact with the negative electrode is covered with the insulating film, the battery container is reliably insulated from the positive electrode and the negative electrode. In addition, an insulation treatment can be completed before the positive electrode and the negative electrode are housed in the battery container.

The molten salt battery according to the present invention has a feature in that the insulating film is an alumite coating film.

In the present invention, the insulating film is formed by an alumite treatment, so that the battery container can be insulated at low costs.

The molten salt battery according to the present invention has a feature in that the insulating film is formed of a fluororesin.

In the present invention, the insulating film is formed by fluororesin coating, so that the insulating film is excellent in chemical resistance, and the film thickness can be increased as compared to alumite.

The molten salt battery according to the present invention has a feature in that the insulating film contains at least one of a polyolefin resin, a polyester resin, a polycarbonate (PC) resin and an acrylic resin.

In the present invention, the insulating film is formed of a polyolefin resin, a polyester resin, a polycarbonate resin or an acrylic resin or a composite thereof, so that the insulating film is inexpensive and excellent in chemical resistance.

The molten salt battery according to the present invention has a feature in that an insulating sheet is interposed between the battery container and the negative electrode.

In the present invention, the insulating sheet is interposed at least at a portion where the battery container and the negative electrode are in contact with each other, so that the battery container are reliably insulated from the positive electrode and the negative electrode. In addition, the battery container can be insulated from the positive electrode and the negative electrode without being processed.

The molten salt battery according to the present invention has a feature in that the insulating sheet is formed of a fluororesin.

In the present invention, the insulating sheet is formed of a fluororesin, so that it is excellent in chemical resistance and has a high degree of freedom in selection of the thickness.

The molten salt battery according to the present invention has a feature in that the insulating sheet contains at least one of a polyolefin resin, a polyester resin, a polycarbonate (PC) resin and an acrylic resin.

In the present invention, the insulating sheet is formed of a polyolefin resin, a polyester resin, a polycarbonate resin or an acrylic resin or a composite thereof, so that the insulating sheet is inexpensive and excellent in chemical resistance.

The molten salt battery according to the present invention has a feature in that the fluororesin contains at least one of polytetrafluoroethylene (PTFE), perfluoroalkoxy (PFA), fluorinated ethylene propylene (FEP), ethylene-tetrafluoroethylene (ETFE), polychlorotrifluoroethylene (PCTFE), ethylene-chlorotrifluoroethylene (ECTFE) and polyvinylidene fluoride (PVDF).

In the present invention, a material that is generally known is used as a fluororesin, so that not only production is easy, but also production costs can be reduced.

The molten salt battery according to the present invention has a feature in that the separator is formed in a bag shape, and the positive electrodes are housed in the bags, respectively.

In the present invention, the positive electrode is housed in a bag-shaped separator, so that when the separator is placed between the positive electrode and the negative electrode, negative electrodes are necessarily positioned at both ends in the direction along which the positive electrode and the negative electrode are stacked.

In addition, the positive electrodes and the negative electrodes are reliably isolated, so that a short circuit is prevented, and also active material falling out of the positive electrode is prevented from being scattered in the battery container.

### Advantageous Effects of Invention

According to the present invention, positive electrodes and negative electrodes alternately stacked such that negative electrodes are positioned at both ends are housed in a battery container while being insulated from the battery container, and the stacked positive/negative electrodes are connected to one another, respectively.

Consequently, the positive electrode no longer contacts an insulating portion between the positive/negative electrodes and the battery container, so that the insulating portion is free from influence of the surface roughness of the positive electrode even when the order of the surface roughness of the positive electrode is greater than the order of the thickness of the insulating portion. For the negative electrode, on the other hand, a current-collector and active material are formed of a metal having a relatively smooth surface, so that the surface roughness of the negative electrode has no influences on the insulating portion even when the negative electrode rubs against the insulating portion. Since all the positive electrodes and the negative electrodes in the battery container can be treated as a pair of a positive electrode and a negative electrode, the battery voltage is not changed by addition of a negative electrode.

Therefore, the insulating portion in the battery container can be prevented from being ruptured without changing the battery voltage even when the positive electrode and the negative electrode are expanded/shrunk.

### BRIEF DESCRIPTION OF DRAWINGS

FIG. 1 is an oblique view schematically showing the configuration of a main section of a molten salt battery according to an embodiment 1 of the present invention.

FIG. 2 is a lateral sectional view schematically showing the configuration of stacked electric power generation elements.

FIG. 3A is a top view schematically showing the configuration of the molten salt battery according to the embodiment 1 of the present invention.

FIG. 3B is a longitudinal sectional view schematically showing the configuration of the molten salt battery.

FIG. 4 is a side perspective view schematically showing a part of a positive electrode that is placed flat.

FIG. 5 is a longitudinal sectional view schematically showing a part of a negative electrode that is placed flat.

FIG. 6 is a sectional view schematically showing the configuration of electric power generation elements stacked for measuring the amount of change in thickness.

FIG. 7 is a lateral sectional view schematically showing the configuration of stacked electric power generation elements of a molten salt battery according to an embodiment 2 of the present invention.

### DESCRIPTION OF EMBODIMENTS

Hereinbelow, the present invention will be described in detail with reference to the drawings showing embodiments thereof.

### Embodiment 1

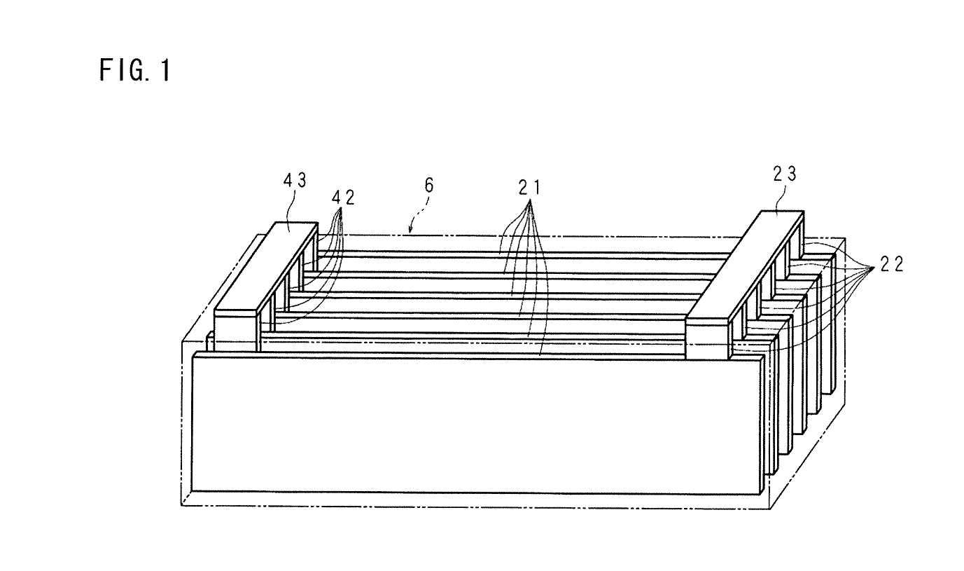

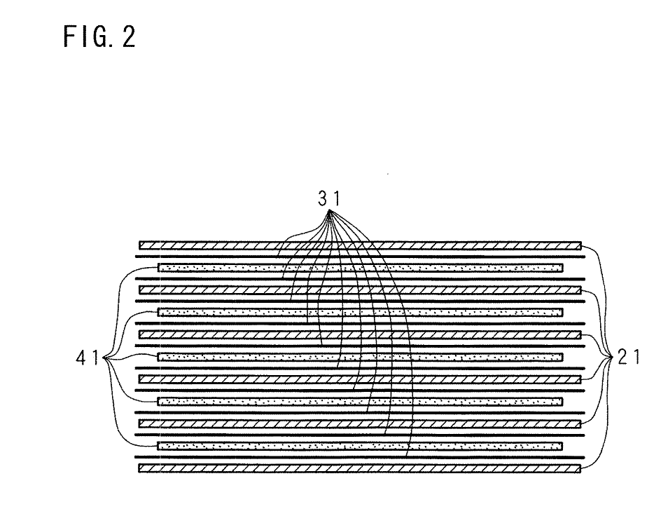

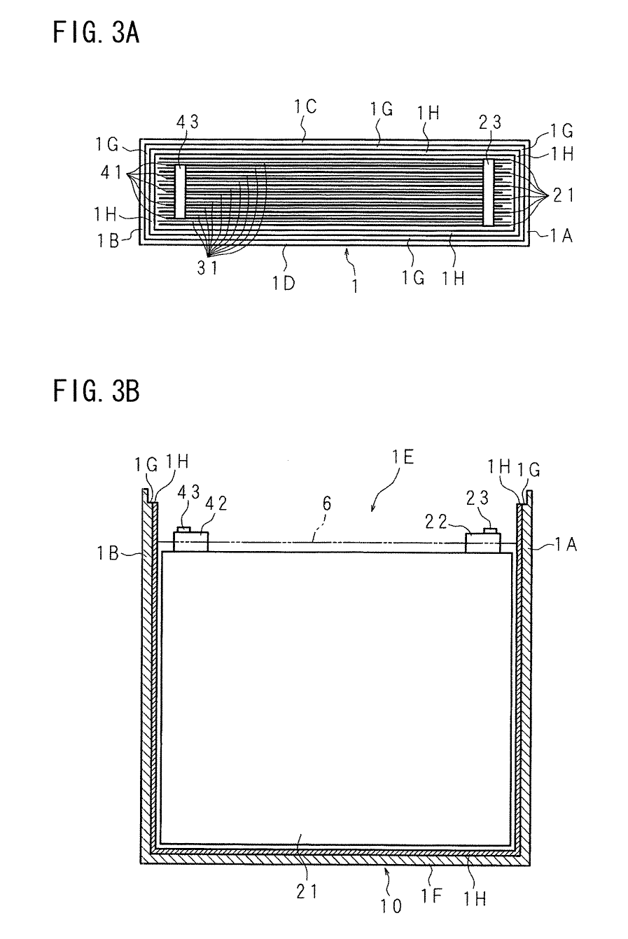

FIG. 1 is an oblique view schematically showing the configuration of a main section of a molten salt battery according to an embodiment 1 of the present invention, FIG. 2 is a lateral sectional view schematically showing the configuration of stacked electric power generation elements, FIG. 3A is a top view schematically showing the configuration of the molten salt battery according to the embodiment 1 of the present invention, and FIG. 3B is a longitudinal sectional view schematically showing the configuration of the molten salt battery.

In the molten salt battery according to this embodiment 1, a plurality of (six in the figure) rectangular plate-like negative electrodes 21, 21, . . . 21 and a plurality of (five in the figure) rectangular plate-like positive electrodes 41, 41, . . . 41 are laterally stacked so as to face each other alternately with rectangular plate-like separators 31, 31, . . . 31 being respectively interposed therebetween. The negative electrode 21 and the separator 31 and the positive electrode 41 form one electric power generation element and in this embodiment 1, five electric power generation elements and one negative electrode 21 are stacked and are housed in a rectangular parallelepiped-shaped battery container 10.

The battery container 10 includes a container body 1 having an opening section 1E on the upper surface, and a rectangular plate-like lid body (not shown) that closes the opening section 1E by being fitted with a step section 1G formed on the inner circumference of the opening section 1E of the container body 1. The container body 1 includes two side walls 1A and 1B located on the side of the short side and two side walls 1C and 1D located on the side of the long side in terms of a side view, and a bottom wall 1F. The battery container 10 is formed of an aluminum alloy (hereinafter, referred to simply as aluminum), and the inner surface of the battery container 10 is insulated by an alumite coating film 1H. The thickness of the alumite coating film 1H is, for example, 20 to 60 μm.

To the upper ends of the negative electrodes 21, 21, . . . 21, the lower ends of rectangular tabs (lead wires) 22, 22, . . . 22 for drawing an electric current are joined on a side close to one side wall, the side wall 1A, located on the side of the short side of the container body 1. The upper ends of the tabs 22, 22, . . . 22 are joined to the lower surface of a rectangular plate-like tab lead 23. To the upper ends of the positive electrodes 41, 41, . . . 41, the lower ends of rectangular tabs 42, 42, . . . 42 for drawing an electric current are joined on a side close to the other side wall, the side wall 1B, located on the side of the short side of the container body 1. The upper ends of the tabs 42, 42, . . . 42 are joined to the lower surface of a rectangular plate-like tab lead 43. Consequently, the above-mentioned five electric power generation elements and one negative electrode 21 are electrically connected in parallel to form one molten salt battery.

The negative electrodes 21, 21, . . . 21 are formed of an aluminum foil plated with tin as negative electrode active material. Aluminum is a material suitable for a current-collector of positive/negative electrodes, and has corrosion resistance to a molten salt. The negative electrodes 21, 21, . . . 21 have a thickness of about 0.14 mm including a plating thickness, and have longitudinal and lateral dimensions of 100 mm and 120 mm, respectively.

The positive electrodes 41, 41, . . . 41 are formed in a plate thickness of about 1 mm by filling a nonwoven fabric formed of fibrous aluminum with a mixture containing a binder, a conduction aid and NaCrO2 as positive electrode active material. The longitudinal and lateral dimensions of the positive electrodes 41, 41, . . . 41 are made smaller than the longitudinal and lateral dimensions of the negative electrodes 21, 21, . . . 21 for preventing generation of a dendrite, and the outer edges of the positive electrodes 41, 41, . . . 41 face the circumferences of the negative electrodes 21, 21, . . . 21 with the separators 31, 31, . . . 31 interposed therebetween.

The separators 31, 31, . . . 31, which are formed of glass paper having a thickness of about 200 μm, are immersed under the position of about 10 mm below the liquid level of a molten salt 6 filled in the rectangular parallelepiped-shaped battery container 10, together with the negative electrodes 21, 21, . . . 21 and the positive electrodes 41, 41, . . . 41. Consequently, somewhat depression of the liquid level is allowed. The tab leads 23 and 43 serve as an external electrode for connecting the whole of stacked electric power generation elements and an external electric circuit, and are positioned above the liquid level of the molten salt 6. The molten salt 6 is formed of, without limitation, an FSI (bisfluorosulfonylimide) or TFSI (bistrifluoromethylsulfonylimide)-based anion and a cation of sodium and/or potassium.

In the configuration described above, the whole battery container 10 is heated to 85° C. to 95° C. by external heating means (not shown), whereby the molten salt 6 is melted to allow charging and discharging.

As described previously, when the molten salt battery is charged, sodium ions are released (deintercalated) from the active material of the positive electrode 41 to thereby increase the volume of the active material, and at the negative electrode 21, plated tin and sodium form an alloy to thereby increase the thickness of the negative electrode 21. When conversely the charged molten salt battery is discharged, sodium ions released from the negative electrode 21 are inserted (intercalated) into the active material of the positive electrode 41 to decrease the volume of the active material of the positive electrode 41, and at the negative electrode 21, sodium is released from the alloy to thereby decrease the thickness of the negative electrode 21.

Thus, the volume of the positive electrode 41 and the thickness of the negative electrode 21 are increased/decreased with charging/discharging of the molten salt battery, so that when the alumite coating film 1H provided on the inner surface of the battery container 10 and the positive electrode 41 or the negative electrode 21 are brought into contact with each other, the alumite coating film 1H may be rubbed and damaged depending on the surface roughness of the positive electrode 41 or the negative electrode 21. The surface roughness of the positive electrode 41 and the negative electrode 21 will now be described.

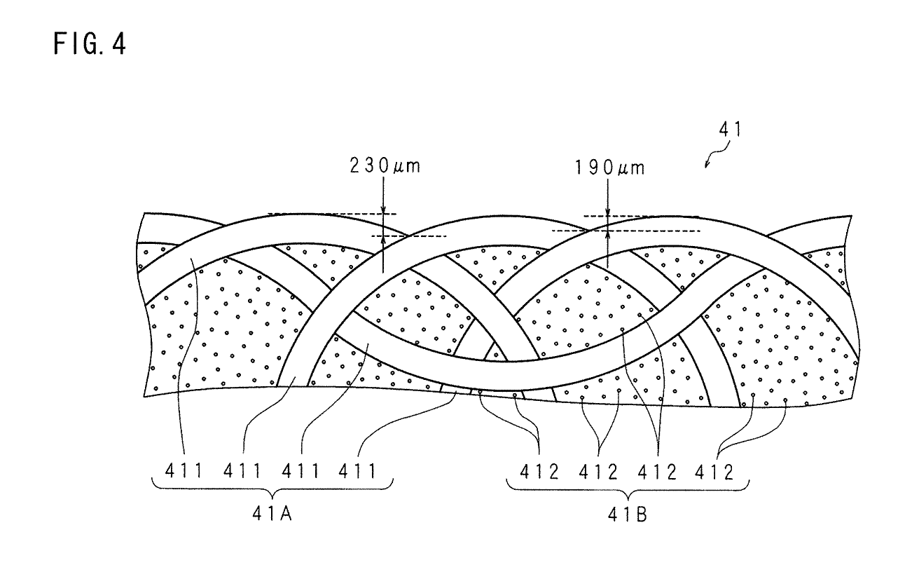

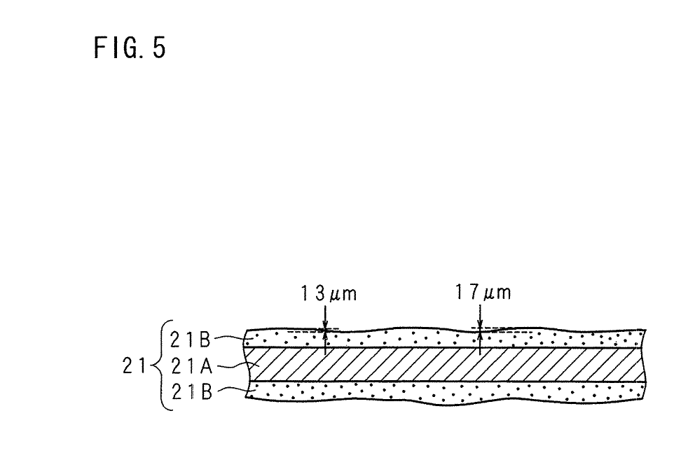

FIG. 4 is a side perspective view schematically showing a part of the positive electrode 41 that is placed flat, and FIG. 5 is a longitudinal sectional view schematically showing a part of the negative electrode 21 that is placed flat.

The positive electrode 41 is formed by filling a nonwoven fabric 41A with a mixture containing the binder, the conduction aid and positive electrode active material 41B, the nonwoven fabric 41A being formed of aluminum for collecting a current from the positive electrode active material while stabilizing the shape of the positive electrode 41. The nonwoven fabric 41A contains a large number of aluminum fibers 411, 411, . . . having a line diameter of 100 μm, and the mixture filled between the aluminum fibers 411, 411, . . . suitably has gaps through which sodium ions can easily pass. The nonwoven fabric 41A is not limited to an aluminum nonwoven fabric, and may be an aluminum woven fabric or a porous material formed of an aluminum alloy. The positive electrode active material 41B is formed by using a large number of granular materials 412, 412, . . . having an average particle diameter of about 10 μm, and the granular materials 412, 412, . . . are held by the binder contained in the mixture filled between the aluminum fibers 411, 411, . . . of the nonwoven fabric 41A.

On the other hand, the negative electrode 21 is such that a tin-plated layer 21B containing tin as negative electrode active material is formed on both surfaces of a negative electrode current-collector 21A formed of an aluminum foil as described previously. The thickness of the negative electrode current-collector 21A is 100 μm, and the thickness of each tin-plated layer 21B is 20 μm.

The aluminum fibers 411, 411, . . . are exposed at the surface of the above-described positive electrode 41 (upper surface in FIG. 4), and more or less irregularities resulting from plating are present on the surface of the negative electrode 21 (upper and lower surfaces in FIG. 5). The surface roughness of each of the positive electrode 41 and the negative electrode 21 was measured at 5 points in a 200 μm square, and an average value was calculated. As a result, the surface roughness (Ry: maximum height defined in Japanese Industrial Standard) of the positive electrode 41 was 210 μm, and the surface roughness of the negative electrode 21 was 15 μm. That is, assuming that the positive electrode 41 having a surface roughness of 210 μm is expanded and shrunk while being contact with the alumite coating film 1H having a thickness of 20 to 60 μm, and they rub against each other, the possibility may be significant that the alumite coating film 1H is damaged by the aluminum fibers 411, 411, . . . thus causing the positive electrode 41 and the battery container 10 to short-circuit. When the negative electrode 21 having a surface roughness smaller by an order of magnitude than that of the positive electrode 41 contacts the alumite coating film 1H, the possibility is very low that the alumite coating film 1H is damaged.

Finally, the actual amount of change in thickness of the positive electrode 41 and the negative electrode 21 will be described below.

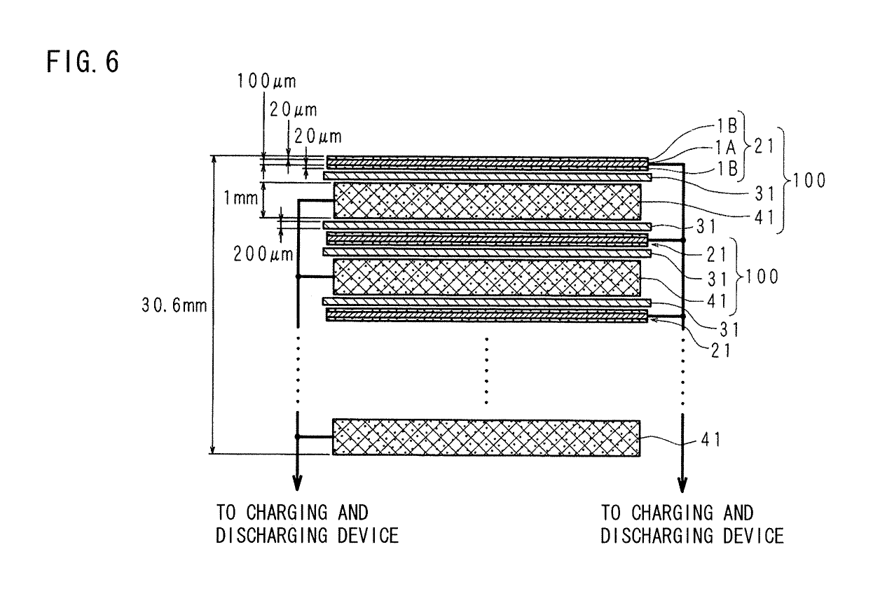

FIG. 6 is a sectional view schematically showing the configuration of electric power generation elements stacked for measuring the amount of change in thickness. In the figure, a reference numeral 100 denotes an electric power generation element, and one electric power generation element 100 is composed of the negative electrode 21, the separator 31 and the positive electrode 41 as described previously. Here, 20 electric power generation elements 100, 100, . . . 100 are stacked with the separator 31 interposed between adjacent electric power generation elements 100 and 100.

The configuration and thickness of the negative electrode 21 are as described previously, the thickness of the negative electrode current-collector 21A is 100 μm, and the thickness of the tin-plated layer 21B formed on each of both surfaces is 20 μm. Similarly as described previously, the thickness of the separator 31 is 200 μm, and the thickness of the positive electrode 41 is 1 mm. Therefore, the thickness of the electric power generation element 100 is 1.34 mm, so that the sum of thicknesses of the 20 electric power generation elements 100, 100, . . . 100 is 30.6 mm (1.34 mm×20+0.2 mm×19).

The negative electrodes 21, 21, . . . 21 and the positive electrodes 41, 41, . . . 41 of the electric power generation elements 100, 100, . . . 100 this stacked were connected to one another, respectively, and the electric power generation elements were connected to a charging and discharging device (not shown), and charged and discharged to measure a change in sum of thicknesses in the stacking direction. As a result, differences in the sum of thicknesses at the time of full charging and at the end of discharging each were 2 mm. That is, the stacked electric power generation elements 100, 100, . . . 100 were found to change in thickness by about 6.5% (2 mm/30.6 mm=0.065) during charging and discharging. Particularly for the positive electrodes 41, 41, . . . 41, it is assumed that a dimensional change comparable to that described above occurs not only in the stacking direction, but also in a direction crossing the stacking direction, and therefore the alumite coating film 1H rubbing against the positive electrode 41 is hard to be prevented from being damaged.

Thus, according to this embodiment 1, negative electrodes are positioned at both ends in the stacking direction along which positive electrodes and negative electrodes are stacked alternately with separators interposed therebetween. The stacked positive electrodes and negative electrodes are housed in a battery container while being insulated from the battery container, and the positive electrodes and the negative electrodes are connected to one another, respectively.

Consequently, the positive electrode no longer contacts an insulating portion between the positive/negative electrodes and the battery container, so that the insulating portion is free from influence of the surface roughness of the positive electrode even when the order of the surface roughness of the positive electrode is greater than the order of the thickness of the insulating portion. For the negative electrode, on the other hand, a tin-plated layer having a relatively smooth surface is formed on a current-collector formed of an aluminum foil, so that the surface roughness of the tin-plated layer has no influences on the insulating portion even when the negative electrode rubs against the insulating portion. Since all the positive electrodes and the negative electrodes in the battery container can be treated as a pair of a positive electrode and a negative electrode, the battery voltage is not changed by placing a restriction on the arrangement of negative electrodes.

Therefore, the insulating portion in the battery container can be prevented from being ruptured without changing the battery voltage even when the positive electrode and the negative electrode are expanded/shrunk.

Further, the insulating film is formed on the inner surface of the battery container, and a portion in contact with the negative electrode is covered with the insulating film, so that the battery container can be reliably insulated from the positive electrode and the negative electrode. In addition, an insulation treatment can be completed before the positive electrode and the negative electrode are housed in the battery container.

Furthermore, an alumite coating film is used as an insulating film, so that the battery container can be insulated at low costs.

In this embodiment 1, the alumite coating film 1H is formed in the battery container 10 as an insulating film, but the present invention is not limited thereto, and, for example, an insulating film may be formed by coating a fluororesin represented by polytetrafluoroethylene (PTFE). In place of the insulating film, for example, an insulating sheet formed of a fluororesin represented by polytetrafluoroethylene (PTFE) may be interposed at a portion where the battery container 10 and the negative electrode 21 contact each other.

When the insulating film is a fluororesin coating or when an insulating sheet formed of a fluororesin is used in place of the insulating film, either the insulating film or the insulating sheet is excellent in chemical resistance, and it is relatively easy to make the film thickness or the sheet thickness larger than the thickness of the alumite coating film. However, for reducing costs and increasing the energy density, it is preferable to reduce the film thickness or the sheet thickness.

The insulating film and the insulating sheet may be formed of a polyolefin resin, a polyester resin, a polycarbonate resin or an acrylic resin or a composite thereof. The polyolefin resin includes polyethylene (PE), polypropylene (PP), polymethylpentene (PMP), polyvinylidene chloride (PVDC) and polybutadiene (BR). The polyester resin includes polyethylene terephthalate (PET), polybutylene terephthalate (PBT) and polybutylene naphthalate (PBN). The acrylic resin includes polyacrylonitrile (PAN) and polymethyl methacrylate (PMMA). When these resins excellent in chemical resistance are used, the insulating film and the insulating sheet can be produced at low costs.

### Embodiment 2

The embodiment 1 has such a form that a rectangular plate-like separator 31 is interposed between a positive electrode 41 and a negative electrode 21, whereas an embodiment 2 has such a form that a positive electrode 41 is housed in a bag-shaped separator 31 to be insulated from a negative electrode 21.

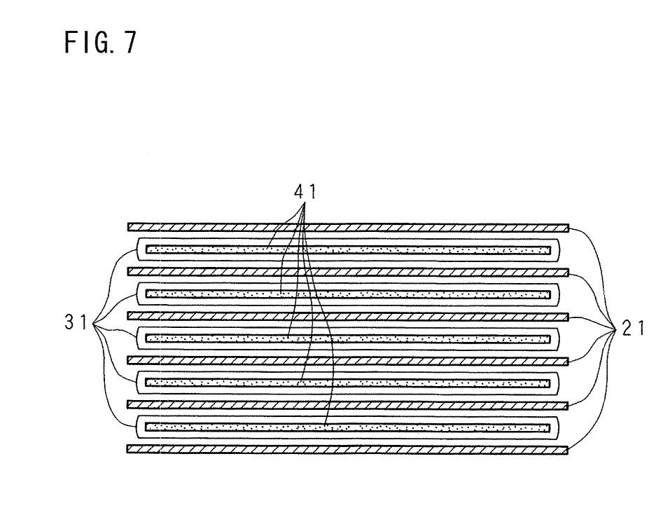

FIG. 7 is a lateral sectional view schematically showing the configuration of stacked electric power generation elements of a molten salt battery according to the embodiment 2 of the present invention.

In the molten salt battery of the present invention, a plurality of (six in the figure) rectangular plate-like negative electrodes 21, 21, . . . 21, and a plurality of (five in the figure) rectangular plate-like positive electrodes 41, 41, . . . 41 housed respectively in bag-shaped separators 31, 31, . . . 31 are laterally arranged so as to face each other alternately along the vertical direction. The negative electrode 21 and the separator 31 and the positive electrode 41 form one electric power generation element and in this embodiment 2, five electric power generation elements and one negative electrode 21 are stacked and are housed in a rectangular parallelepiped-shaped battery container 10. The separators 31, 31, . . . 31, are made of a film of a fluororesin having resistance to a molten salt at temperature at which a molten salt battery is operated, and are formed such that they are porous and have a bag shape.

In addition, parts corresponding to those in the embodiment 1 are given the same symbols, and detailed descriptions thereof are omitted.

Thus, according to this embodiment 2, the positive electrode is housed in a bag-shaped separator, so that when the separator is used without waste, negative electrodes are necessarily positioned at both ends in the direction along which the positive electrode and the negative electrode are stacked.

Not only a short circuit between the positive electrode and the negative electrode can be reliably prevented, but also active material falling out of the positive electrode can be prevented from being scattered in the battery container.

Furthermore, the number of negative electrodes that are thinner and less expensive than positive electrodes can be made greater than the number of positive electrodes to increase the battery capacity and the energy density.

Embodiments that are disclosed herein should be considered illustrative, rather than limiting, in all respects. The scope of the present invention is defined not by the foregoing descriptions but by the appended claims, and all changes are intended to be included within descriptions and scopes equivalent to the appended claims.

### REFERENCE SIGNS LIST

1: Container Body
1H: Alumite Coating Film (Insulating Film)
21: Negative Electrode
31: Separator
41: Positive Electrode
6: Molten Salt
10: Battery Container

1. A molten salt battery comprising a positive electrode and a negative electrode housed in a battery container formed of a conductor, the positive electrode and the negative electrode facing each other with a separator interposed therebetween, the separator containing a molten salt, wherein the battery container is insulated against the positive electrode and the negative electrode;
one or more of the positive electrodes, and a plurality of the separators and negative electrodes are included, respectively;
the positive electrodes and the negative electrodes are stacked alternately, with negative electrodes placed at both ends in the stacking direction; and
the positive electrodes and the negative electrodes are connected to one another in parallel, respectively.

2. The molten salt battery according to claim 1, wherein an insulating film is formed partially or entirely on the inner surface of the battery container.

3. The molten salt battery according to claim 2, wherein the insulating film is an alumite coating film.

4. The molten salt battery according to claim 2, wherein the insulating film is formed of a fluororesin.

5. The molten salt battery according to claim 2, wherein the insulating film contains at least one of a polyolefin resin, a polyester resin, a polycarbonate (PC) resin and an acrylic resin.

6. The molten salt battery according to claim 1, wherein an insulating sheet is interposed between the battery container and the negative electrode.

7. The molten salt battery according to claim 6, wherein the insulating sheet is formed of a fluororesin.

8. The molten salt battery according to claim 6, wherein the insulating sheet contains at least one of a polyolefin resin, a polyester resin, a polycarbonate (PC) resin and an acrylic resin.

9. The molten salt battery according to claim 4, wherein the fluororesin contains at least one of polytetrafluoroethylene (PTFE), perfluoroalkoxy (PFA), fluorinated ethylene propylene (FEP), ethylene-tetrafluoroethylene (ETFE), polychlorotrifluoroethylene (PCTFE), ethylene-chlorotrifluoroethylene (ECTFE) and polyvinylidene fluoride (PVDF).

10. The molten salt battery according to claim 7, wherein the fluororesin contains at least one of polytetrafluoroethylene (PTFE), perfluoroalkoxy (PFA), fluorinated ethylene propylene (FEP), ethylene-tetrafluoroethylene (ETFE), polychlorotrifluoroethylene (PCTFE), ethylene-chlorotrifluoroethylene (ECTFE) and polyvinylidene fluoride (PVDF).

11. The molten salt battery according to claim 1, wherein the separator is formed in a bag shape, and the positive electrodes are housed in the bags, respectively.

12. The molten salt battery according to claim 2, wherein the separator is formed in a bag shape, and the positive electrodes are housed in the bags, respectively.

13. The molten salt battery according to claim 3, wherein the separator is formed in a bag shape, and the positive electrodes are housed in the bags, respectively.

14. The molten salt battery according to claim 4, wherein the separator is formed in a bag shape, and the positive electrodes are housed in the bags, respectively.

15. The molten salt battery according to claim 5, wherein the separator is formed in a bag shape, and the positive electrodes are housed in the bags, respectively.

16. The molten salt battery according to claim 6, wherein the separator is formed in a bag shape, and the positive electrodes are housed in the bags, respectively.

17. The molten salt battery according to claim 7, wherein the separator is formed in a bag shape, and the positive electrodes are housed in the bags, respectively.

18. The molten salt battery according to claim 8, wherein the separator is formed in a bag shape, and the positive electrodes are housed in the bags, respectively.

19. The molten salt battery according to claim 9, wherein the separator is formed in a bag shape, and the positive electrodes are housed in the bags, respectively.

20. The molten salt battery according to claim 10, wherein the separator is formed in a bag shape, and the positive electrodes are housed in the bags, respectively.
